(19) United States
(12) Patent Application Publication
(10) Pub. No.: US 2015/0177847 A1
(43) Pub. Date: Jun. 25, 2015

(54) TECHNIQUES FOR RESOLVING KEYBOARD AND INPUT METHOD AMBIGUITY ON COMPUTING DEVICES

(71) Applicant: Google Inc., Mountain View, CA (US)

(72) Inventors: Luke Hiro Swartz, San Francisco, CA (US); Vladimir Lanin, Tel Aviv (IL); Kirill Buryak, Sunnyvale, CA (US); Roozbeh Pournader, San Francisco, CA (US)

(73) Assignee: GOOGLE INC., Mountain View, CA (US)

(21) Appl. No.: 14/138,667

(22) Filed: Dec. 23, 2013

(51) Int. Cl. G06F 3/02

(52) U.S. Cl. CPC G06F 3/02

(57) ABSTRACT

A computer-implemented method can include receiving an input via a first keyboard associated with a first language. The method can include determining a first character string based on the input and the first keyboard. The method can include determining a first probability score indicative of a likelihood that the first character string is appropriate in the first language. The method can include determining a second character string based on the input and a second keyboard associated with a second language when the first probability score is less than a first threshold. The method can include determining a second probability score indicative of a likelihood that the second character string is appropriate in the second language. Based on the probability scores, the method can also include generating an output including at least one of the first and character strings.

### FIELD

The present disclosure generally relates to input methods for computing devices and, more particularly, to techniques for techniques for resolving keyboard and input method ambiguity on computing devices.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A user can provide input to a computing device (a desktop computer, a laptop computer, a tablet computer, a mobile phone, etc.) via a keyboard. The keyboard can be either a physical keyboard connected to the computing device or a virtual keyboard displayed on a touch display of the computing device. For example, the user may input a string of characters by selecting a sequence of keys of the keyboard. The computing device can then interpret the touch input with respect to a known layout of the keyboard to determine the string of characters.

### SUMMARY

A computer-implemented method is presented. The method can include receiving, at a computing device having one or more processors, an input via a first keyboard associated with the computing device, wherein the first keyboard is associated with a first language. The method can include determining, at the computing device, a first string of characters based on the input and the first keyboard. The method can include determining, at the computing device, a first probability score indicative of a likelihood that the first string of characters is appropriate in the first language. The method can include determining, at the computing device, a second string of characters based on the input and a second keyboard when the first probability score is less than a first threshold indicative of an appropriate level of confidence for the first string of characters, wherein the second keyboard is associated with a second language. The method can include determining, at the computing device, a second probability score indicative of a likelihood that the second string of characters is appropriate in the second language. The method can also include generating, at the computing device, an output based on the first and second probability scores and the first threshold, the output including at least one of the first and second strings of characters.

In some embodiments, determining the second string of characters includes determining, at the computing device, the second string of characters based on (i) the first string of characters and (ii) a mapping between the first keyboard and the second keyboard.

In other embodiments, the mapping defines a relationship between each character of the first keyboard and each character of the second keyboard.

In some embodiments, wherein the first and second keyboards are virtual keyboards, and wherein determining the first and second strings of characters is further based on a spatial input model.

In other embodiments, the first and second probability scores are determined by comparing the first and second strings of characters to first and second dictionaries associated with the first and second languages, respectively.

In some embodiments, the first and second dictionaries are user-specific dictionaries.

In other embodiments, the output includes the first string of characters or the second string of characters.

In some embodiments, the output further includes the first string of characters when the first probability score is greater than or equal to the second probability score, and the output includes the second string of characters when the second probability score is greater than the first threshold.

In other embodiments, the output further includes a suggestion to switch and/or automatically switching from the first keyboard to the second keyboard when the second probability score is greater than the first threshold.

In some embodiments, the output includes a suggestion to switch and/or automatically switching from the first keyboard to the second keyboard when the second probability score is greater than the first threshold.

In other embodiments, the computer-implemented method further comprises receiving, at the computing device, a list of preferred or frequently utilized languages, wherein the list of languages includes the first and second languages.

A computing device is also presented. The computing device can include a communication device and one or more processors. The communication device can be configured to receive an input via a first keyboard, wherein the first keyboard is associated with a first language. The one or more processors can be configured to determine a first string of characters based on the input and the first keyboard. The one or more processors can be configured to determine a first probability score indicative of a likelihood that the first string of characters is appropriate in the first language. The one or more processors can be configured to determine a second string of characters based on the input and a second keyboard when the first probability score is less than a first threshold indicative of an appropriate level of confidence for the first string of characters, wherein the second keyboard is associated with a second language that is utilized by the user. The one or more processors can be configured to determine a second probability score indicative of a likelihood that the second string of characters is appropriate in the second language. The one or more processors can also be configured to generate an output based on the first and second probability scores and the first threshold, the output including at least one of the first and second strings of characters.

In some embodiments, the one or more processors are configured to determine the second string of characters based on (i) the first string of characters and (ii) a mapping between the first keyboard and the second keyboard.

In other embodiments, the mapping defines a relationship between each character of the first keyboard and each character of the second keyboard.

In some embodiments, wherein the first and second keyboards are virtual keyboards, and wherein the one or more processors are further configured to determine the first and second strings of characters based on a spatial input model.

In other embodiments, the one or more processors are further configured to determine the first and second probability scores by comparing the first and second strings of characters to first and second dictionaries associated with the first and second languages, respectively.

In some embodiments, the first and second dictionaries are user-specific dictionaries.

In other embodiments, the output includes the first string of characters or the second string of characters.

In some embodiments, the output further includes the first string of characters when the first probability score is greater than or equal to the second probability score, and wherein the output includes the second string of characters when the second probability score is greater than the first threshold.

In other embodiments, the output further includes a suggestion to switch and/or automatically switching from the first keyboard to the second keyboard when the second probability score is greater than the first threshold.

In some embodiments, the output further includes a suggestion to switch and/or automatically switching from the first keyboard to the second keyboard when the second probability score is greater than the first threshold.

In other embodiments, the one or more processors are further configured to receive a list of preferred or frequently utilized languages, wherein the list of languages includes the first and second languages.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a diagram of an example computing system according to some implementations of the present disclosure;

FIG. 2 is a functional block diagram of an example computing device of the example computing system of FIG. 1;

FIGS. 3A-3B are diagrams of two example keyboards according to some implementations of the present disclosure; and

FIG. 4 is a flow diagram of an example technique for resolving keyboard and input method ambiguity on computing devices according to some implementations of the present disclosure.

### DETAILED DESCRIPTION

A user of a computing device, e.g., a mobile phone, may be multilingual and, therefore, may be capable of providing input to the computing device in each of multiple languages. Each of these multiple languages, however, can be associated with a different physical or virtual keyboard. In the case of a physical keyboard, the computing device may only have a single physical keyboard connected to it at a given time, and thus input method editor (IME) software executing on the computing device can interpret the input from the user according to a particular language. For example, each key of the physical keyboard may have two or more labels corresponding to two or more languages. The particular language being utilized by the IME, however, may not be the language in which the user intends to provide input. In the case of a virtual keyboard, the user may accidentally provide touch input in an intended language that is different than a language corresponding to the displayed virtual keyboard. These situations can result in mistyping. Switching between these keyboard and language settings can be difficult and//or time consuming.

Accordingly, techniques are presented for resolving keyboard and input method ambiguity on computing devices. The techniques include determining a string of characters based on a user input to a first keyboard corresponding to a first language and then determining whether the first string of characters is ambiguous. The term “ambiguous” can refer to the first string of characters not matching, or not being within a threshold of matching, any entries of a dictionary corresponding to the first language. When a match is not found, the techniques can then try other keyboards, e.g., other keyboard layouts, and/or other dictionaries, e.g., user-specific dictionaries. More specifically, the techniques can then determine second strings of characters corresponding to other keyboards and/or determine matches using other dictionaries.

If a match is found, the corresponding keyboard and/or dictionary can be deemed appropriate for the input. The techniques can then suggest that the user switch to the other keyboard and/or dictionary, can automatically switch to the other keyboard and/or dictionary, and/or can replace the first string of characters with the second string of characters. In the case of a physical keyboard, the IME can utilize a different keyboard layout for interpreting input, and in the case of a virtual keyboard, the computing device can display and utilize the different virtual keyboard. While the techniques of the present disclosure are described as being performed at a computing device, it should be appreciated that the techniques can be at least partially performed at a remote server (retrieving a user's universal language settings (ULS), determining which other keyboards to try, retrieving user-specific dictionaries, scoring, etc.).

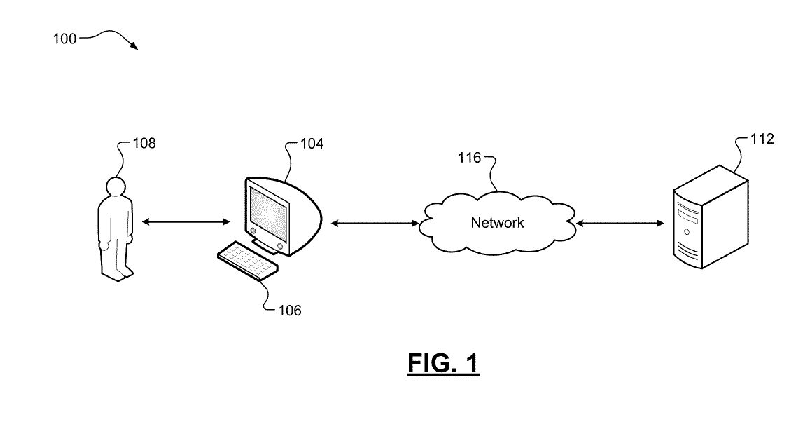

Referring now to FIG. 1, an example computing system 100 is illustrated. The computing system 100 can include a computing device 104 (hereinafter “computing device 104”). The computing device 104 can be any suitable computing device for receiving input from a user 108 via a physical keyboard 106 or a virtual keyboard (a desktop computer, a laptop computer, a tablet computer, a mobile phone, etc.). As previously mentioned, the physical keyboard 106 may have a plurality of physical keys each having character labels in two or more different languages. The computing device 104 can also communicate with a server 112 via a network 116. The server 112 can be any suitable computing device configured to communicate with the computing device 104 via the network 116. It should be appreciated that the term “server” as used herein can refer to both a single server and two or more servers operating in a parallel or distributed architecture. The network 116 can be a local area network (LAN), a wide area network (WAN), e.g., the Internet, or a combination thereof.

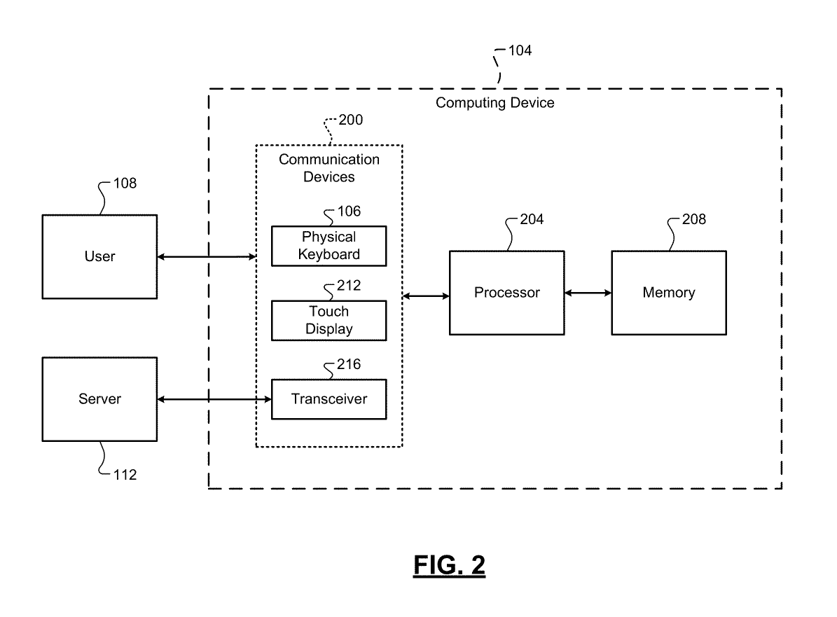

Referring now to FIG. 2, a functional block diagram of the computing device 104 is illustrated. The computing device 104 can include communication devices 200, a processor 204, and a memory 208. It should be appreciated that the term “processor” as used herein can refer to both a single processor and two or more processors operating in a parallel or distributed architecture. The memory 208 can be any suitable storage medium configured to store information at the computing device 104 (flash, hard disk, etc.).

The communication devices 200 can include any suitable devices for communicating with the computing device 104. For example, the communication devices 200 can include the physical keyboard 106, a touch display 212, and a transceiver 216. The touch display 212 can be configured for communication between the user 108 and the computing device 104. The transceiver 216 can be configured for communication between the server 112 and the computing device 104, e.g., via the network 116. In one implementation, the transceiver 216 can receive a list of languages preferred or frequently utilized by the user 108 (including the first and second languages) from the server 112 via the network 116, and can then provide the list of languages to the processor 204. It should be appreciated that the computing device 104 may only include the physical keyboard 106 for receiving user input, and thus the touch display 212 may be a non-touch display.

The processor 204 can control operation of the computing device 104. Specifically, the processor 204 can control operations including, but not limited to, loading/executing an operating system of the computing device 104, processing information input via the physical keyboard 106 and/or the touch display 212, processing information received via the transceiver 216, controlling information output via the touch display 212 and/or the transmitted via the transceiver 216, and/or controlling read/write operations at the memory 208. The processor 204 can also wholly or partially execute the techniques of the present disclosure, as is described in further detail below.

The processor 204 can control various input methods. In one implementation, the processor 204 can execute IME software that is used for interpreting input from the user 108 via the physical keyboard 106. In another implementation, the processor 204 can control the touch display 212 to display a virtual keyboard and can interpret input via the virtual keyboard. For example, the processor 204 may be configured to interpret input according to a default physical keyboard or may be configured to display a default virtual keyboard, such as an English keyboard. The physical keyboard or virtual keyboard initially being utilized to interpret the user input can be referred to as a first keyboard. The user 108 can then provide input via the first keyboard. Accordingly, the processor 204 can then interpret the input with respect to the first keyboard to determine a first string of characters. The first string of characters can represent a sequence of keys of the first keyboard that the user 108 selected. For the following examples, the user 108 is bilingual in English and Russian, although other and/or more languages could be utilized.

The processor 204 can determine whether the first string of characters is ambiguous. The first string of characters can be ambiguous when a first probability score for the first string of characters is less than a first threshold. The first probability score can indicate a likelihood that the first string of characters is appropriate in the first language, and the first threshold can indicate an acceptable likelihood that the first string of characters was intended by the user 108.

Examples of a string of characters being “appropriate” can include the first string of characters matching an entry of a dictionary or being substantially similar to an entry of a dictionary. The term “substantially similar” can refer to the string of characters being within a threshold from a match to an entry in a dictionary. For example, the first string of characters may be appropriate even though the first string of characters is misspelled by one letter (“apropriate” vs. “appropriate”). It should be appreciated that any suitable algorithms can be used to determine how similar the first string of characters is to one or more entries in a dictionary in order to determine whether the first string of characters is appropriate for purposes of the present disclosure.

To determine the first probability score, the processor 204 can compare the first string of characters to entries in a dictionary corresponding to the first language, e.g., an English dictionary. This comparison can include utilizing an algorithm, e.g., a Soundex algorithm, and the dictionary to generate the first probability score. For example, the dictionary may be a user-specific dictionary that is customized for the user 108. In some implementations, the processor 204 may first compare the first string of characters to a default or standard dictionary, and if no match is found, the processor 204 may then compare the first string of characters to the user-specific dictionary.

When the first probability score is greater than or equal to the first threshold, e.g., it represents a Soundex “match,” the processor 204 can determine that the first string of characters is not ambiguous. This determination can also be referred to as a “pass,” and the first keyboard is determined to be acceptable for the input by the user 108. When the first probability score is less than the first threshold, however, the processor 204 can then determine a second string of characters based on the input and a second keyboard. This determination can also be referred to as a “fail,” and the first keyboard can be determined to not be acceptable for the input by the user 108. The second keyboard can correspond to a second language, e.g., Russian, which is utilized by the user 108. The second language can be a single language or one of a plurality of languages that is utilized by the user 108. For example, the second language(s) can be determined based on preferences of the user 108, such as language settings.

The processor 204 can determine the second string of characters by using a mapping between the first keyboard and the second keyboard. This mapping can represent relationships between characters of the first keyboard and characters of the second keyboard. For example, the mapping may define a specific Unicode character that corresponds to a key of the first and second keyboards and thus one or more characters in each of the first and second languages. In some implementations, a plurality of different keyboards may exist for a particular second language, e.g., Russian. In such cases, the processor 204 may determine the second string of characters for each of the different keyboards for the second language. Alternatively, the processor 204 may select a most common one of the different keyboards for the second language or a user-preferred keyboard for the second language.

When the first and second keyboards are virtual keyboards, there may be no direct mapping between the first virtual keyboard and the second virtual keyboard. For example, the first and second virtual keyboards may have different sizes, different numbers of keys, or other lack of correspondence. In these cases, the processor 204 may use a spatial input model to determine which keys of the second virtual keyboard correspond to the initial input by the user 108 with respect to the first virtual keyboard. More specifically, the processor 204 may store the positions of the input with respect to the first virtual keyboard, and then utilize the spatial input model to determine which keys most likely correspond to the input by the user 108 in order to determine the second string of characters. In other words, the spatial input model can compare the physical layout and the assignment of keys on the first virtual keyboard to the physical layout and the assignment of keys on the second virtual keyboard, and then match the keys with the same physical placement to have corresponding characters in the first language and the second language.

The processor 204 can determine a second probability score for the second string of characters. The second probability score can indicate a likelihood that the second string of characters is appropriate in the second language, and can be determined in a same or similar manner as the first probability score. When the second probability score is greater than the first threshold, the processor 204 can determine that the second string of characters is not ambiguous. Again, this determination can be referred to as a “pass,” and the second keyboard can be determined to be acceptable for the input by the user 108. When the second probability score is less than the first threshold, the processor 204 can determine that the second string of characters is also ambiguous. Again, this determination can be referred to as a “fail,” and the processor 204 can continue trying other keyboards and/or other dictionaries, e.g., user-specific dictionaries, until a string of characters passes the first threshold.

In some implementations, when the first and second probability scores are both less than the first threshold, the processor 204 may default to utilizing the first keyboard and the first string of characters. For example, the processor 204 may default to the first keyboard and the first string of characters when the first and second probability scores are equal. In some implementations, however, when the second probability score is greater than the first probability score by greater than a second threshold but still less than the first threshold, the processor 204 may determine that the second keyboard and the second string of characters are more appropriate than the first keyboard and the first string of characters. The second threshold can indicate an acceptable degree of confidence that the second keyboard and the second string of characters are more appropriate than the first keyboard and the first string of characters.

The processor 204 can generate an output based on the first and second probability scores and the first threshold. When the first string of characters passes, the output can be the continuing use of the first keyboard and the continued display of the first string of characters, e.g., the display may remain the same. When the first string of characters fails and the second string of characters passes, however, the output can be different. More specifically, the output can include a suggestion for the user 108 to switch from the first keyboard to the second keyboard. Alternatively, the output may automatically switch from the first keyboard to the second keyboard. For example, if the first keyboard is the physical keyboard 106, the switching can involve switching an IME executing on the computing device 104 from interpreting user input using a layout of the first keyboard to using a layout of the second keyboard. Alternatively, for example, if the first keyboard is a virtual keyboard, the switching can involve changing from displaying and utilizing the first keyboard to displaying and utilizing the second keyboard. In addition to or instead of the suggestion/automatic switching, the output may include replacing the first string of characters with the second string of characters.

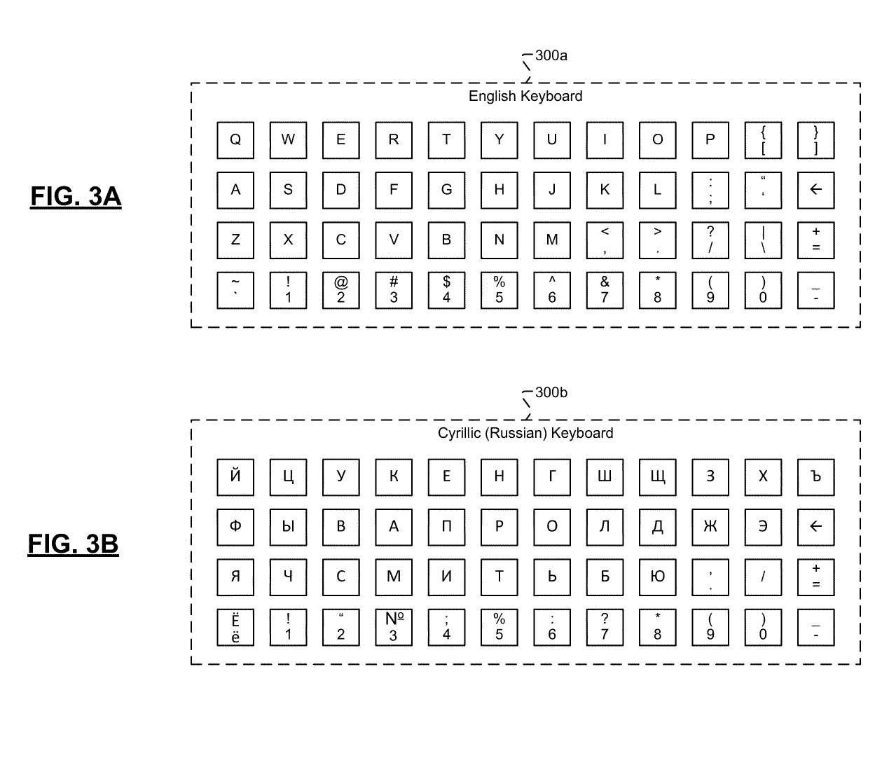

Referring now to FIGS. 3A-3B, diagrams of example keyboards 300a and 300b are illustrated. More specifically, FIG. 3A illustrates an example English keyboard 300a, and FIG. 3B illustrates an example Cyrillic (Russian) keyboard 300b. The mapping between the keyboards 300a and 300b can be summarized in Table 1 below. For example, each character in English and Cyrillic (Russian) may be assigned a specific Unicode character, and the mapping may define relationships between the various Unicode characters in the different languages.

TABLE 1
English [symbol] Cyrillic (Russian) Virtual Keyboard Mapping

| | | | | | | |
|---|---|---|---|---|---|---|
| Q [symbol] [symbol] | W [symbol] [symbol] | E [symbol] [symbol] | R [symbol] [symbol] | T [symbol] E | Y [symbol] H | U [symbol] [symbol] |
| I [symbol] [symbol] | O [symbol] [symbol] | P [symbol] 3 | { [ [symbol] X | } ] [symbol] [symbol] | A [symbol] φ | S [symbol] [symbol] |
| D [symbol] B | F [symbol] A | G [symbol] Π | H [symbol] P | J [symbol] O | K [symbol] [symbol] | L [symbol] [symbol] |
| : ; [symbol] [symbol] | “ ‘ [symbol] [symbol] | Z [symbol] [symbol] | X [symbol] [symbol] | C [symbol] C | V [symbol] M | B [symbol] [symbol] |
| N [symbol] T | M [symbol] [symbol] | < , [symbol] [symbol] | > . [symbol] [symbol] | ? / [symbol] , . | I \ [symbol] / | ~ \grave{ } [symbol] Ë ë |
| | | | 3 [symbol] N^{o} | | | |

As previously discussed, when utilizing a virtual keyboard, the user 108 may have provided the input in an intended language, e.g., Russian, which is different than a language corresponding to the virtual keyboard, e.g., English. Alternatively, when utilizing the physical keyboard 106, the IME executing on the computing device 104 may interpret user input using a keyboard layout that is different than the layout of the physical keyboard 106. This can result in a mistyping. For example only, the user 108 may intend to input the Russian word “ [symbol] ,” which means “earthquake” in English. When the English keyboard 300a is displayed/utilized instead of the Russian keyboard 300b, however, the input by the user 108 may be determined by the computing device 104 to be a first string of characters “ptvktnhzctybt.”

The computing device 104 can calculate the first probability score for the first string of characters “ptvktnhzctybt” and determine that the first probability score is less than the first threshold. As previously mentioned, the first threshold can be indicative of an appropriate level of confidence that the string of characters “ptvktnhzctybt” was intended by the user 108. The computing device 104 can utilize an English dictionary to determine the first probability score for the first string of characters. In some implementations, the computing device 104 may utilize a user-specific English dictionary that is customized for the user 108, because the user 108 may often input non-traditional spellings. In some implementations, the computing device 104 can utilize a suitable algorithm, e.g., a Soundex algorithm, for determining the first probability score.

When it is determined that the first probability score is less than the first threshold, the computing device 104 can determine a second string of characters “ [symbol] ” based on the input and a second keyboard that is utilized by the user 108. For example, the user 108 may have utilized the Cyrillic (Russian) keyboard 300b in the past. The computing device 104 can then calculate a second probability score for the second string of characters “ [symbol] .” Again, the computing device 104 can utilize a Russian dictionary to determine the second probability score for the second string of characters. Similarly, in some implementations the computing device 104 may utilize a user-specific Russian dictionary that is customized for the user 108. As stated above, in some implementations the computing device 104 can utilize a suitable algorithm, e.g., a Soundex algorithm, for determining the second probability score.

The computing device 104 can generate an output based on the first and second probability scores and the first threshold. In this example, the second probability score for the second string of characters may be relatively high because the second string of characters “ [symbol] ” is likely to appear in most or all Russian dictionaries. Therefore, the computing device 104 can output a suggestion for the user 108 to switch from the first keyboard 300a to the second keyboard 300b. Additionally or alternatively, the computing device 104 can also replace the first string of characters with the second string of characters. In some cases, the computing device 104 may also automatically switch from the first virtual 300a to the second keyboard 300b, as well as replace the first string of characters with the second string of characters. For example, if the first keyboard is the physical keyboard 106, the switching can involve switching an IME executing on the computing device 104 from interpreting user input using a layout of the first keyboard to using a layout of the second keyboard. Alternatively, for example, if the first keyboard is a virtual keyboard, the switching can involve changing from displaying and utilizing the first keyboard to displaying and utilizing the second keyboard.

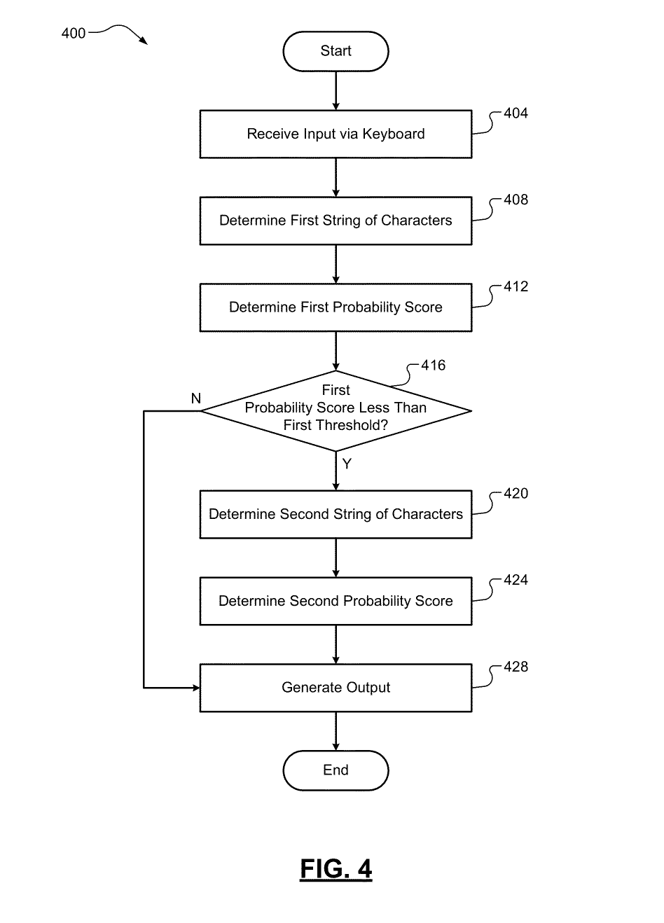

Referring now to FIG. 4, a flow diagram of an example technique 400 for resolving keyboard and input method ambiguity on computing devices is illustrated. At 404, the computing device 104 can receive an input from the user 108 via a first keyboard associated with the computing device 104, the first keyboard being associated with a first language, e.g., English. At 408, the computing device 104 can determine a first string of characters based on the input and the first keyboard. At 412, the computing device 104 can determine a first probability score indicative of a likelihood that the first string of characters is appropriate in the first language. For example, the computing device 104 may determine the first probability score by comparing the first sting of characters to entries of a first dictionary in the first language, such as a user-specific first dictionary that is customized for the user 108.

At 416, the computing device 104 can determine whether the first probability score is less than a first threshold indicative of an appropriate level of confidence that the first string of characters was intended by the user 108. If the first probability score is less than the first threshold, the technique 400 can proceed to 420. Otherwise, the technique 400 can proceed to 428. At 420, the computing device 104 can determine a second string of characters based on the input and a second keyboard that is associated with a second language that is utilized by the user 108, e.g., Russian. At 424, the computing device 104 can determine a second probability score indicative of a likelihood that the second string of characters is appropriate in the second language. For example, the computing device 104 may determine the second probability score by comparing the second string of characters to entries of a second dictionary in the second language, such as a user-specific dictionary that is customized for the user 108.

At 428, the computing device 104 can generate an output based on the first and second probability scores and the first threshold. More specifically, when the first probability score is greater than or equal to the first threshold, the computing device 104 can continue displaying the first keyboard because no ambiguity exists. Alternatively, when the second probability score is greater than or equal to the first threshold, the computing device 104 can automatically switch or suggest to the user 108 to switch from the first keyboard to the second keyboard. For example, if the first keyboard is the physical keyboard 106, the switching can involve switching an IME executing on the computing device 104 from interpreting user input using a layout of the first keyboard to using a layout of the second keyboard. Alternatively, for example, if the first keyboard is a virtual keyboard, the switching can involve changing from displaying and utilizing the first keyboard to displaying and utilizing the second keyboard. Additionally or alternatively, the computing device 104 can replace the first string of characters with the second string of characters when the second probability score is greater than the first threshold. The technique 400 can then end or return to 404 for one or more additional cycles.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method, comprising:
receiving, at a computing device having one or more processors, an input via a first keyboard associated with the computing device, wherein the first keyboard is associated with a first language;
determining, at the computing device, a first string of characters based on the input and the first keyboard;
determining, at the computing device, a first probability score indicative of a likelihood that the first string of characters is appropriate in the first language;
determining, at the computing device, a second string of characters based on the input and a second keyboard when the first probability score is less than a first threshold indicative of an appropriate level of confidence for the first string of characters, wherein the second keyboard is associated with a second language;
determining, at the computing device, a second probability score indicative of a likelihood that the second string of characters is appropriate in the second language; and
generating, at the computing device, an output based on the first and second probability scores and the first threshold, the output including at least one of the first and second strings of characters.

2. The computer-implemented method of claim 1, wherein determining the second string of characters includes determining, at the computing device, the second string of characters based on (i) the first string of characters and (ii) a mapping between the first keyboard and the second keyboard.

3. The computer-implemented method of claim 2, wherein the mapping defines a relationship between each character of the first keyboard and each character of the virtual keyboard.

4. The computer-implemented method of claim 2, wherein the first and second keyboards are virtual keyboards, and wherein determining the first and second strings of characters is further based on a spatial input model.

5. The computer-implemented method of claim 1, wherein the first and second probability scores are determined by comparing the first and second strings of characters to first and second dictionaries associated with the first and second languages, respectively.

6. The computer-implemented method of claim 5, wherein the first and second dictionaries are user-specific dictionaries.

7. The computer-implemented method of claim 1, wherein the output includes the first string of characters or the second string of characters.

8. The computer-implemented method of claim 7, wherein the output further includes the first string of characters when the first probability score is greater than or equal to the second probability score, and wherein the output includes the second string of characters when the second probability score is greater than the first threshold.

9. The computer-implemented method of claim 8, wherein the output further includes a suggestion to switch from the first keyboard to the second keyboard when the second probability score is greater than the first threshold.

10. The computer-implemented method of claim 1, wherein the output includes a suggestion to switch from the first keyboard to the second keyboard when the second probability score is greater than the first threshold.

11. The computer-implemented method of claim 1, wherein the output includes automatically switching from the first keyboard to the second keyboard when the second probability score is greater than the first threshold.

12. The computer-implemented method of claim 1, further comprising receiving, at the computing device, a list of preferred or frequently utilized languages, wherein the list of languages includes the first and second languages.

13. A computing device, comprising:
a communication device configured to receive an input via a first keyboard, wherein the first keyboard is associated with a first language; and
one or more processors configured to:
determine a first string of characters based on the input and the first keyboard;
determine a first probability score indicative of a likelihood that the first string of characters is appropriate in the first language;
determine a second string of characters based on the input and a second keyboard when the first probability score is less than a first threshold indicative of an appropriate level of confidence for the first string of characters, wherein the second keyboard is associated with a second language;
determine a second probability score indicative of a likelihood that the second string of characters is appropriate in the second language; and
generate an output based on the first and second probability scores and the first threshold, the output including at least one of the first and second strings of characters.

14. The computing device of claim 13, wherein the one or more processors are configured to determine the second string of characters based on (i) the first string of characters and (ii) a mapping between the first keyboard and the second keyboard.

15. The computing device of claim 14, wherein the mapping defines a relationship between each character of the first keyboard and each character of the second keyboard.

16. The computing device of claim 14, wherein the first and second keyboards are virtual keyboards, and wherein the one or more processors are further configured to determine the first and second strings of characters based on a spatial input model.

17. The computing device of claim 13, wherein the one or more processors are further configured to determine the first and second probability scores by comparing the first and second strings of characters to first and second dictionaries associated with the first and second languages, respectively.

18. The computing device of claim 17, wherein the first and second dictionaries are user-specific dictionaries.

19. The computing device of claim 13, wherein the output includes the first string of characters or the second string of characters.

20. The computing device of claim 19, wherein the output further includes the first string of characters when the first probability score is greater than or equal to the second probability score, and wherein the output includes the second string of characters when the second probability score is greater than the first threshold.

21. The computing device of claim 20, wherein the output further includes a suggestion to switch from the first keyboard to the second keyboard when the second probability score is greater than the first threshold.

22. The computing device of claim 13, wherein the output further includes a suggestion to switch from the first keyboard to the second keyboard when the second probability score is greater than the first threshold.

23. The computing device of claim 13, wherein the output includes automatically switching from the first keyboard to the second keyboard when the second probability score is greater than the first threshold.

24. The computing device of claim 13, wherein the one or more processors are further configured to receive a list of preferred or frequently utilized languages, wherein the list of languages includes the first and second languages.
